(19) United States
(12) Patent Application Publication
(10) Pub. No.: US 2016/0134049 A1
(43) Pub. Date: May 12, 2016

(54) WATERPROOF CONNECTOR

(71) Applicant: YAZAKI CORPORATION, Tokyo (JP)

(72) Inventors: Masayuki KATAOKA, Kakegawa-shi, Shizuoka (JP); Fuminori SUGIYAMA, Kakegawa-shi, Shizuoka (JP); Hiroshi KAWAMURA, Makinohara-shi, Shizuoka (JP)

(73) Assignee: Yazaki Corporation, Tokyo (JP)

(21) Appl. No.: 14/896,066

(22) PCT Filed: Jul. 2, 2014
(86) PCT No.: PCT/JP2014/067676

§ 371 Date: Dec. 4, 2015

(30) Foreign Application Priority Data
Jul. 2, 2013 (JP) 2013-138792

(51) Int. Cl. H01R 13/52; H01R 13/6581

(52) U.S. Cl. CPC H01R 13/5205; H01R 13/6581

(57) ABSTRACT

Seal members (3) are a double-sided tape having a resin thin base material layer (13) and a pair of adhesive layers (14). As the seal members (3), a first seal member (15) and a second seal member (16) are provided. The first seal member (15) is disposed in a plate section (12) of an intermediate section (9) of a terminal fitting (2). In addition, the second seal member (16) is disposed in an insulator (6) of an end of a high-voltage electric wire (1). The thin base material layer (13) has front and rear surfaces, and the heat resistance, and is formed as a base material of thin layer shape. The pair of adhesive layers (14) is respectively integrally provided on the front and rear surfaces of the thin base material layer (13).

### TECHNICAL FIELD

The present invention relates to a waterproof connector that is formed by embedding an electrical connection portion in a connector housing by mold forming.

### BACKGROUND ART

For example, electrical connection is provided between an inverter unit and a battery, and between the inverter unit and a motor unit, which are mounted on a hybrid vehicle or an electric vehicle, by a high-voltage wire harness. A connector having waterproofing properties, that is a waterproof connector, is provided in an end of the wire harness.

A technique according to a configuration and a structure of the waterproof connector is disclosed in the following PTL 1. Hereinafter, the technique is described with reference to FIG. 6. A waterproof connector 101 is configured to include a metal terminal fitting 103 provided in an end of an electric wire 102, a resin connector housing 105 that is formed by embedding a portion to be mold-formed 104, and seal members 106 and 107 that prevent entering of water from an outside of the connector housing 105 to a connection portion between the electric wire 102 and the terminal fitting 103.

The portion to be mold-formed 104 described above corresponds to a range from an intermediate portion 108 of the terminal fitting 103 to a sheath cover section 109 of the end of the electric wire 102 and the portion to be mold-formed 104 is embedded in the connector housing 105.

The seal members 106 and 107 are made of silicone rubber or butyl rubber and materially have elasticity and adhesion properties. The seal members 106 and 107 are formed by allowing such a material to be a tape shape. The seal member 106 formed in the tape shape is wound around the intermediate portion 108 of the terminal fitting 103. Furthermore, the seal member 107 is wound around the sheath cover section 109 of the end of the electric wire 102. The seal members 106 and 107 are embedded together with the portion to be mold-formed 104 along with molding of the connector housing 105.

### CITATION LIST

### Patent Literature

[PTL 1] JP-A-2009-252712

### SUMMARY OF INVENTION

### Technical Problem

In the waterproof connector 101 of the related art described above, since the seal members 106 and 107 having elasticity and the like are used, there is a problem that the seal members 106 and 107 are likely to be deformed by heat of a resin material and then molding defects are caused when the connector housing 105 is molded. Furthermore, there is a concern that an uneven thickness occurs in the seal members 106 and 107, in other words, the thicknesses of the seal members 106 and 107 are not constant, and the like when the connector housing 105 is molded. Thus, there is also a problem that expected waterproofing properties cannot be obtained.

In order to obtain sufficient waterproofing properties after molding the connector housing 105, it is necessary to mold the connector housing 105 while applying a pressure to the seal members 106 and 107 having elasticity. This is performed to maintain a watertight state (waterproof state) by the elasticity of the seal members 106 and 107. Thus, if the pressure is small when molding, the expected waterproofing properties are not obtained.

The present invention is made in view of the situations described above and an object of the present invention is to provide a waterproof connector capable of ensuring stable waterproofing properties and moldability.

### Solution to Problem

The present invention that is made to solve the problems described above provides a waterproof connector including: a metal terminal fitting that has an electrical contact section, an electric wire connection section, and an intermediate section positioned between the electrical contact section and the electric wire connection section, and is provided in an electric wire end through the electric wire connection section; a resin connector housing in which a portion to be mold-formed including the intermediate section of the terminal fitting and a sheath cover section of the electric wire end is embedded; and a seal member that is disposed in the portion to be mold-formed and prevents entering of water from an outside of the connector housing to the electric wire connection section, wherein the seal member is a double-sided tape that has a thin base material layer having heat resistance and adhesive layers that are respectively integrally provided on front and rear surfaces of the thin base material layer.

The waterproof connector according to the present invention having such a feature is formed by employing the double-sided tape as the seal member. Since the adhesive layers of the front and rear surfaces of the double-sided tape come into close contact with the portion to be mold-formed including the intermediate section of the terminal fitting and the sheath cover section of the electric wire end, entering of water from the outside of the connector housing is prevented. Specifically, even if slight irregularities exist between the electric wire connection section and the connector housing, or between the sheath cover section and the connector housing, since the adhesive layer comes into close contact with the portion to be mold-formed in a state where adhesive enters the slight irregularities, formation of an entering path of water is prevented and thereby waterproofing properties are ensured. Furthermore, according to the present invention, the thin base material layer is employed as a base material of the double-sided tape. If the thin base material layer is formed in a thin layer shape and is formed by a material that does not has elasticity, molding defects can be prevented without being deformed by a pressure and the like when the connector housing is molded.

Furthermore, in the waterproof connector of the present invention, the seal member includes a first seal member disposed in the intermediate section and a second seal member disposed in the sheath cover section.

The waterproof connector according to the present invention having such a feature, employs the first seal member and the second seal member as the seal member. If the first seal member and the second seal member are disposed in front and rear of the electrical connection portion, entering of water from the outside of the connector housing to the electrical connection portion is reliably prevented.

### Advantageous Effects of Invention

According to the present invention, since the double-sided tape is employed as the seal member, an effect that stable waterproofing properties and moldability can be ensured is achieved compared to the related art.

According to the present invention, since the seal member formed of the first seal member and the second seal member is employed and is disposed in the front and rear of the electrical connection portion, an effect that waterproofing can be reliably provided is achieved.

### BRIEF DESCRIPTION OF DRAWINGS

FIG. 1 is a sectional view of a main portion of a waterproof connector of the present invention.

FIG. 2 is a perspective view of a terminal fitting and an electric wire end.

FIG. 3 is a perspective view illustrating when a first seal member and a second seal member are provided from a state of FIG. 2.

FIG. 4 is a perspective view illustrating when a connector housing is molded from a state of FIG. 3.

FIG. 5 is a perspective view illustrating when formation of the waterproof connector is completed by providing a shield shell and the like from a state of FIG. 4.

FIG. 6 is a sectional view of a waterproof connector of a related art.

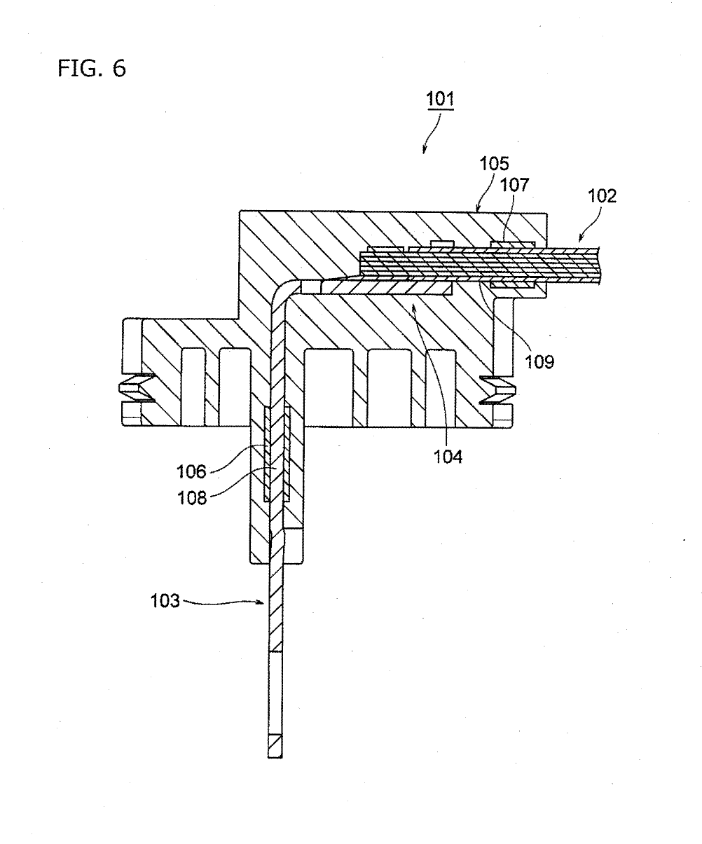

### DESCRIPTION OF EMBODIMENTS

A waterproof connector is configured to include a metal terminal fitting, a resin connector housing, and a seal member disposed in a portion to be mold-formed. The seal member is a double-sided tape having a thin base material layer that has front and rear surfaces and heat resistance, and a pair of adhesive layers that are respectively integrally provided on the front and rear surfaces of the thin base material layer.

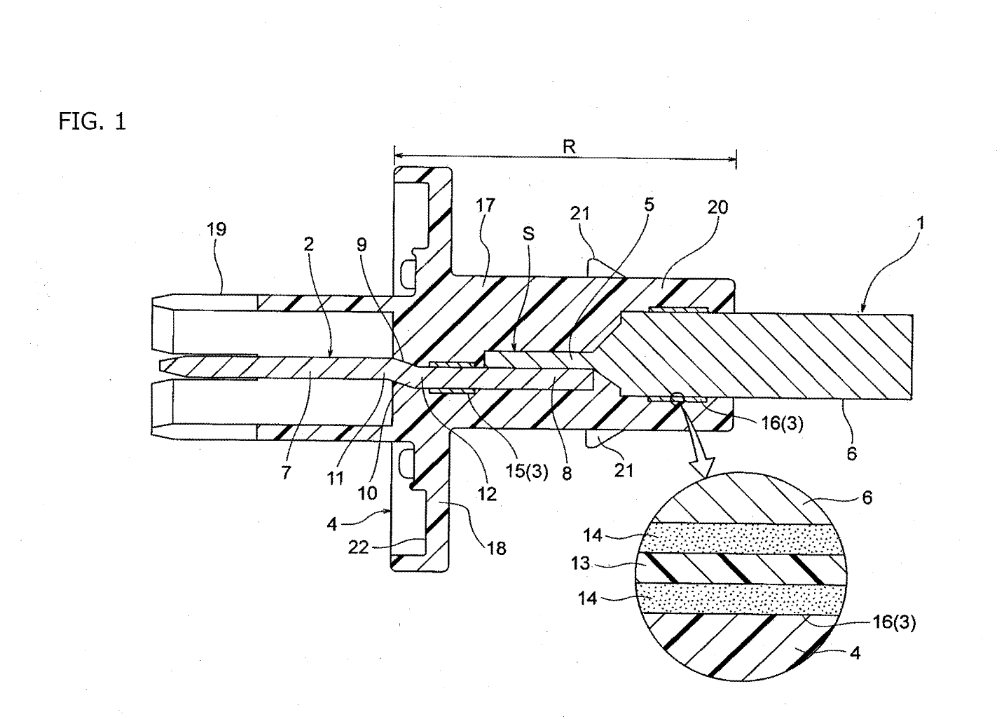

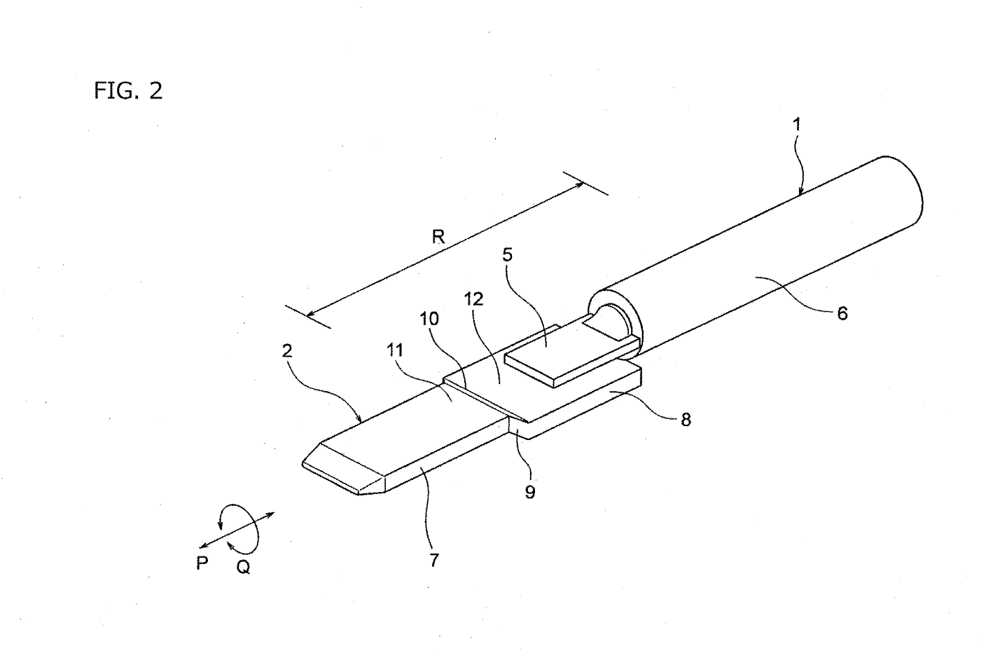

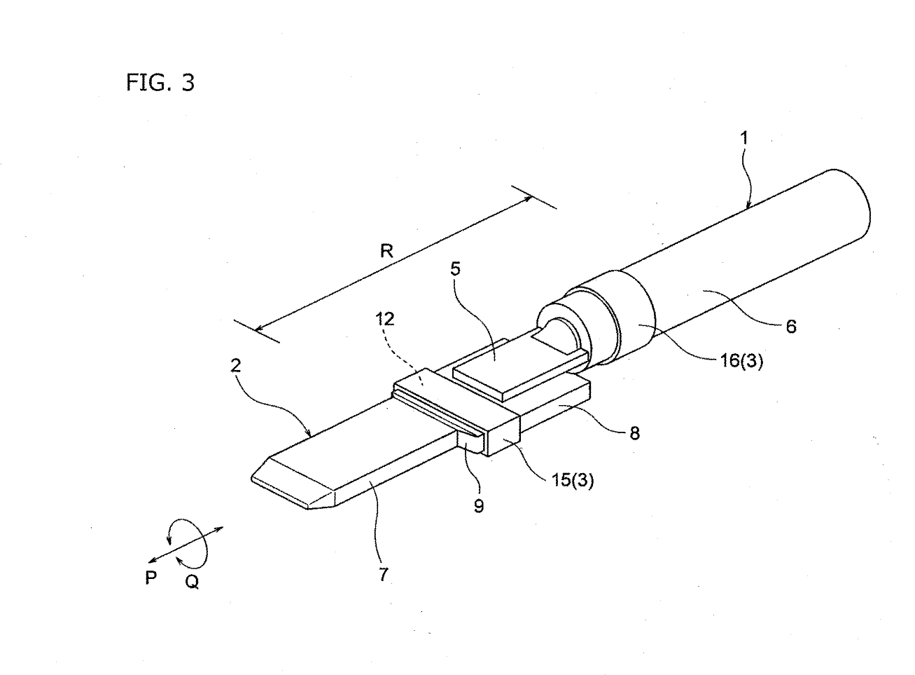

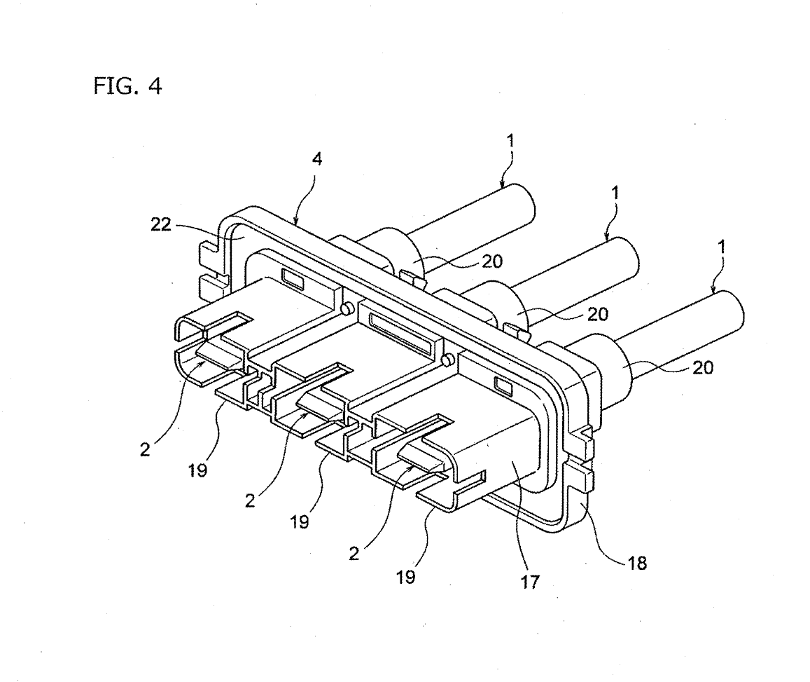

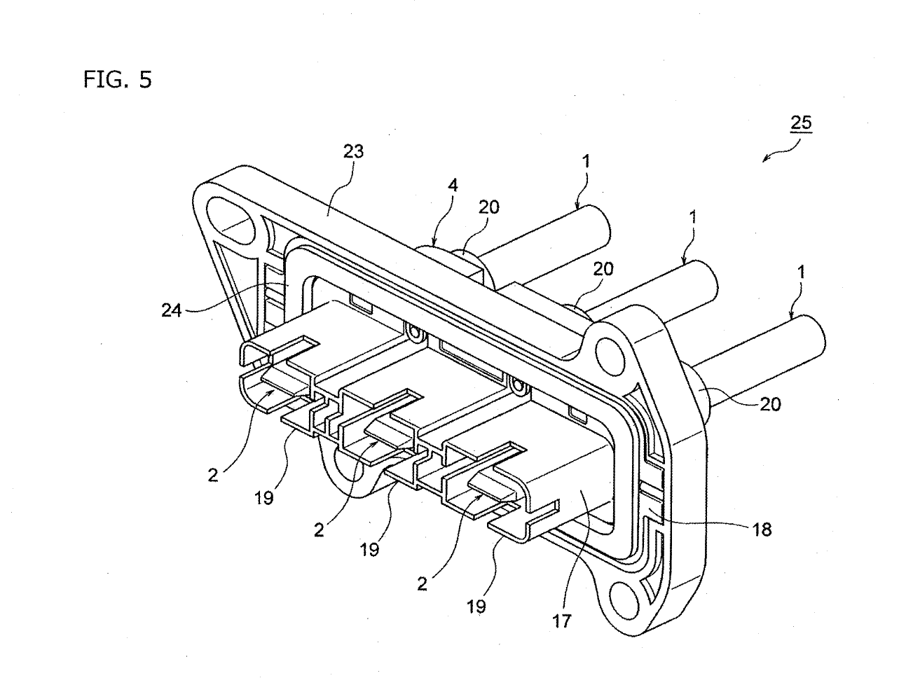

Hereinafter, an example will be described with reference to the drawings. FIG. 1 is a sectional view of a main portion of a waterproof connector. Furthermore, FIG. 2 is a perspective view of a terminal fitting and an electric wire end, FIG. 3 is a perspective view illustrating when a first seal member and a second seal member are provided from a state of FIG. 2, FIG. 4 is a perspective view illustrating when a connector housing is molded from a state of FIG. 3, and FIG. 5 is a perspective view illustrating when formation of the waterproof connector is completed by providing a shield shell from a state of FIG. 4.

Here, a part of a shielded connector is illustrated in FIG. 1 (see FIG. 5 for an external shape of the shielded connector). In addition, the shielded connector is an example of the waterproof connector of the present invention. Reference numeral 1 indicates a high-voltage electric wire (electric wire), reference numeral 2 indicates a terminal fitting, reference numeral 3 indicates a seal member, reference numeral 4 indicates a connector housing in the drawings. First, a detailed structure of each configuration described above will be described.

The high-voltage electric wire 1 is a high-voltage conductive path for electrically connecting an inverter unit and a motor unit mounted on, for example, a vehicle (not illustrated), and three high-voltage electric wires 1 are provided if the two units described above are connected. The high-voltage electric wire 1 is configured to include a conductor 5 and an insulator 6 (sheath cover section) that covers the conductor 5. The high-voltage electric wire 1 is formed in a circular cross section. An end of the high-voltage electric wire 1 is processed such that the insulator 6 is removed by a predetermined length and the conductor 5 is exposed. The conductor 5 is made of aluminum, aluminum alloy, copper, copper alloy, and the like, and here, a conductor structure (conductor structure is an example) formed of twisted electric wires is employed.

The insulator 6 is formed by extruding a resin material having insulating properties on the outside of the conductor 5. As the resin material, polyethylene-based resin, polypropylene-based resin, polyvinyl chloride resin, and the like are exemplified. The insulator 6 is formed of a general resin material.

In FIGS. 1 and 2, the terminal fitting 2 is formed by press forming a metal plate of copper or copper alloy. Here, the terminal fitting 2 is formed in a substantially strip shape of which an intermediate portion is stepped. The terminal fitting 2 having such a shape has an electrical contact section 7 that is connected to a counterpart terminal (not illustrated), an electric wire connection section 8 to which the conductor 5 of the end of the high-voltage electric wire 1 is connected, and an intermediate section 9 that is positioned between the electrical contact section 7 and the electric wire connection section 8.

The electrical contact section 7 is formed in a tab-shape as illustrated in the drawings. In addition, in the example, the electrical contact section 7 is a male type, but for example, the electrical contact section 7 is formed in a box shape if the electrical contact section 7 is a female type. The electrical contact section 7 is disposed within a connector fitting section 19 in a housing body section 17 of the connector housing 4 described below.

The intermediate section 9 is formed so as to connect the electrical contact section 7 and the electric wire connection section 8 in an intermediate portion of the terminal fitting 2. The intermediate section 9 is formed in a substantially crank shape having a stepped section 10, a plate section 11 that is disposed on the electrical contact section 7 side, and a plate section 12 that is disposed on the electric wire connection section 8 side in which the stepped section 10 is interposed therebetween.

Front and rear surfaces of the plate section 12 on the electric wire connection section 8 side are formed as flat surfaces. In addition, both side surfaces are also formed as surfaces having a typical machining roughness. That is, the plate section 12 is formed in the same state as the electrical contact section 7 or the plate section 11 on the electrical contact section 7 side without performing special processing. A first seal member 15 described below is disposed in the plate section 12. In addition, the following description is given in which an arrow P is defined as an axial direction of the terminal fitting 2 and an arrow Q is defined as a circumferential direction of the terminal fitting 2 or the plate section 12 in FIG. 2.

The electric wire connection section 8 is formed in a plate shape. Specifically, the electric wire connection section 8 is formed in a shape formed by directly stretching the plate section 12 on the rear side in the axial direction. The electric wire connection section 8 is electrically connected to the conductor 5 of the end of the high-voltage electric wire 1. In the example, the electric wire connection section 8 is connected to the conductor 5 by welding in a state where the conductor 5 is crushed. In addition, the connection by welding is an example and other connection methods may be employed. That is, for example, the connection may be provided by forming a well-known wire barrel and crimping the electric wire connection section 8 and the conductor 5 using the wire barrel.

In FIGS. 1 and 3, the seal members 3 are provided as members for preventing entering of water from an outside of the connector housing 4 to the electrical connection portion. Specifically, the seal members 3 are provided as members for preventing entering of water to a connection portion between the electric wire connection section 8 of the terminal fitting 2 and the conductor 5 of the high-voltage electric wire 1. The seal members 3 are disposed at positions described below in a predetermined range R including the intermediate section 9 of the terminal fitting 2 and the insulator 6 of the end of the high-voltage electric wire 1.

In addition, a part of the terminal fitting 2 and a part of the high-voltage electric wire 1 included in the predetermined range R correspond to a portion to be mold-formed S.

The seal member 3 is a double-sided tape having a resin thin base material layer 13 and a pair of adhesive layers 14. The waterproof connector of the present invention includes the first seal member 15 and a second seal member 16 as the seal members 3. The first seal member 15 is disposed in the plate section 12 of the intermediate section 9 of the terminal fitting 2. In addition, the second seal member 16 is disposed in the insulator 6 of the end of the high-voltage electric wire 1. Each of the first seal member 15 and the second seal member 16 are formed in a strip shape. A reason for forming the first seal member 15 and the second seal member 16 in the strip shape is that wiring is facilitated when winding the first seal member 15 and the second seal member 16 at the disposition positions described above in the circumferential direction (arrow Q).

The thin base material layer 13 has front and rear surfaces, and heat resistance. Furthermore, the thin base material layer 13 is a thin layer shape and is formed as a base material when stacking together with the pair of adhesive layers 14. In the example, a resin film is employed as the thin base material layer 13. In addition, the thin base material layer 13 does not have elasticity of which deformation occurs when the connector housing 4 is molded.

The pair of adhesive layers 14 are configured of two layers and each layer is integrally provided in one of the front and rear surfaces of the thin base material layer 13. Each of the pair of adhesive layers 14 has a shape in which adhesive is layered and comes into close contact with the plate section 12 of the intermediate section 9 of the terminal fitting 2 or the insulator 6 of the end of the high-voltage electric wire 1. As the pair of adhesive layers 14, a layer of acryl-based adhesive layer or a rubber-based adhesive layer is suitable. In addition, this is an example and the present invention is not limited to the example. Furthermore, it is preferable that adhesive enters slight irregularities. The pair of adhesive layers 14 are protected by release paper (not illustrated) before using the seal member 3.

The seal member 3 (first seal member 15 and the second seal member 16) is formed to have a length such that one end of the seal member 3 is overlapped on the other end thereof when being wound in the arrow Q as illustrated in FIG. 3. In addition, width dimensions of the first seal member 15 and the second seal member 16 are set to be appropriate lengths in consideration of the space of the plate section 12 of the intermediate section 9 and the like.

Referring back to FIG. 1, the connector housing 4 is a resin molded product having insulating properties and has the housing body section 17 and a flange section 18 connected to an intermediate portion of the housing body section 17.

The connector fitting section 19 where the electrical contact section 7 of the terminal fitting 2 is disposed on the inside thereof and a mold section 20 in which the portion to be mold-formed S is embedded are integrally formed in the housing body section 17. The connector fitting section 19 is a fitting portion connected to a counterpart connector and is formed in a box shape. The mold section 20 is formed as a solid portion having a predetermined external shape. Engagement protrusions 21 are formed on an outer surface of the mold section 20 as engagement portions with respect to a shield shell 23 described later (see FIG. 5).

The flange section 18 is formed in a collar shape protruding outwardly from the intermediate portion of the housing body section 17. In the example, the flange section 18 is formed as a portion abutting a shield case of the inverter unit or the motor unit. A packing receiving groove 22 is formed in the flange section 18. The packing receiving groove 22 is formed in a groove shape to be circular.

Next, an assembling step (operation) of the shielded connector will be described with reference to the configuration and the structure described above.

In FIG. 2, in a first step, an operation of connecting the conductor 5 of the end of the high-voltage electric wire 1 and the electric wire connection section 8 of the terminal fitting 2 is performed. As a connection method, an appropriate method such as welding, depositing, and soldering is employed. In the example, the connection is performed by welding.

In FIG. 3, in a second step, an operation of disposing the first seal member 15 in the plate section 12 of the intermediate section 9 of the terminal fitting 2 and an operation of disposing the second seal member 16 in the insulator 6 of the end of the high-voltage electric wire 1 are performed. The first seal member 15 and the second seal member 16 are disposed in the predetermined range R including the intermediate section 9 of the terminal fitting 2 and the insulator 6 of the end of the high-voltage electric wire 1. The first seal member 15 and the second seal member 16 are disposed by coming into close contact with the plate section 12 and the insulator 6 by being wound in the Q direction illustrated in FIG. 3. In this case, the adhesive layers 14 of one side come into close contact with the plate section 12 and the insulator 6. The adhesive layers 14 come into close contact with the plate section 12 and the insulator 6 in a state where adhesive enters slight irregularities if the slight irregularities exist in the plate section 12 and the insulator 6. Thus, the first seal member 15 and the second seal member 16 are wound without a gap.

In FIG. 4, in a third step, an operation of resin-molding the connector housing 4 is performed. The resin molding is performed in a state where the terminal fitting 2 in which the first seal member 15 and the second seal member 16 are disposed, are set in the mold of the connector housing 4. The connector housing 4 is resin-molded so that the portion to be mold-formed S is embedded (see FIG. 1). Since the first seal member 15 and the second seal member 16 include the thin base material layer 13 which has the heat resistance and is in a thin layer shape, the first seal member 15 and the second seal member 16 are embedded without being deformed during molding of the connector housing 4.

After the resin molding, when the connector housing 4 is taken out from the mold, as illustrated in FIG. 1, the adhesive layers 14 of the other side of the first seal member 15 and the second seal member 16 are in a state of coming into close contact with the connector housing 4 in the portion to be mold-formed S. The terminal fitting 2 is water-tightly fixed in accordance with the resin molding of the connector housing 4.

In FIG. 5, in a fourth step, an assembling operation of the metal shield shell 23, a rubber unit packing 24, and the like with respect to the connector housing 4 is performed. Furthermore, a fixing operation of a shield member (for example, cylindrical braid, metal foil, and the like) (not illustrated) for collectively covering three high-voltage electric wires 1 that are cylindrically formed is performed with respect to the shield shell 23. In addition, fixing of the shield member is performed by using a metal shield ring (not illustrated). When sequentially going through the fourth step, assembly of a shielded connector 25 having waterproofing properties is completed.

Above, as described with reference to FIGS. 1 to 5, according to the shielded connector 25, the seal members 3 are included to ensure waterproofing properties. The seal member 3 employs the double-sided tape having the thin base material layer 13 and the pair of adhesive layers 14, and the waterproof connector includes the first seal member 15 and the second seal member 16 as the seal members 3 having this configuration. Since the close contact state is reliably formed by having the adhesive layers 14, entering of water from the outside of the connector housing 4 is prevented. Specifically, even if slight irregularities exist between the plate section 12 and the mold section 20, or between the insulator (sheath cover section) 6 and the mold section 20, due to a state where adhesive enters therebetween to close contact the slight irregularities, formation of the entering path of water is prevented and thereby waterproofing properties are ensured.

Furthermore, according to the shielded connector 25, the thin base material layer 13 is employed as the base material of the double-sided tape. The thin base material layer 13 is formed in a thin layer shape and is formed by a material that does not have elasticity. Thus, deformation due to a pressure and the like of resin molding of the connector housing 4 does not occur, and as a result, molding defects can be prevented.

Thus, according to the present invention, since the seal member 3 that is the double-sided tape is employed, an effect that stable waterproofing properties and moldability can be ensured is achieved compared to an example of the related art. Furthermore, since the first seal member 15 and the second seal member 16 are disposed in the front and the rear of the electrical connection portion, an effect that waterproofing can be reliably provided is also achieved.

It is obvious that the present invention can be variously modified within a scope which does not change the gist of the present invention.

Here, features of the embodiment of the waterproof connector according to the present invention described above are briefly summarized and listed in the following [1] and [2].

[1] A waterproof connector (shielded connector 25) includes

A metal terminal fitting (2) that has an electrical contact section (7), an electric wire connection section (8), and an intermediate section (9) positioned between the electrical contact section and the electric wire connection section, and is provided in the electric wire (high-voltage electric wire 1) end through the electric wire connection section,

a resin connector housing (4) in which a portion to be mold-formed (S) including the intermediate section of a terminal fitting and a sheath cover section of a electric wire end is embedded, and

a seal member (15 and 16) that is disposed in the portion to be mold-formed and prevent entering of water from the outside of the connector housing to the electric wire connection section,

wherein the seal member is the double-sided tape that has the thin base material layer (13) having heat resistance and adhesive layers (14) that are respectively integrally provided on front and rear surfaces of the thin base material layer.

[2] The waterproof connector (shielded connector 25) according to [1],

wherein the seal members include a first seal member (15) that is disposed in the intermediate section and a second seal member (16) disposed in the sheath cover section.

The present invention is described with reference to the detailed or specific embodiment, and is apparent to those skilled in the related art that it is possible to make various changes and modifications without departing from the scope of the present invention.

This application is based on Japanese patent application filed on Jul. 2, 2013 (Japanese Patent Application No. 2013-138792) the contents of which are incorporated herein by reference.

### INDUSTRIAL APPLICABILITY

According to the present invention, since the double-sided tape is employed as the seal member, an effect that stable waterproofing properties and moldability can be ensured is achieved compared to the related art. The present invention achieving the effects is useful for the waterproof connector formed by embedding the electrical connection portion in the connector housing by mold forming.

### REFERENCE SIGNS LIST

R . . . predetermined range

S . . . portion to be mold-formed

1 . . . high-voltage electric wire (electric wire)

2 . . . terminal fitting

3 . . . seal member

4 . . . connector housing

5 . . . conductor

6 . . . insulator (sheath cover section)

7 . . . electrical contact section

8 . . . electric wire connection section

9 . . . intermediate section

10 . . . stepped section

11, 12 . . . plate section

13 . . . thin base material layer

14 . . . adhesive layer

15 . . . first seal member

16 . . . second seal member

17 . . . housing body section

18 . . . flange section

19 . . . connector fitting section

20 . . . mold section

21 . . . engagement protrusion

22 . . . packing receiving groove

23 . . . shield shell

24 . . . unit packing

25 . . . shielded connector (waterproof connector)

1. A waterproof connector comprising:
a metal terminal fitting that has an electrical contact section, an electric wire connection section, and an intermediate section positioned between the electrical contact section and the electric wire connection section, and is provided in an electric wire end through the electric wire connection section;
a resin connector housing in which a portion to be mold-formed including the intermediate section of the terminal fitting and a sheath cover section of the electric wire end is embedded; and
a seal member that is disposed in the portion to be mold-formed and prevents entering of water from an outside of the connector housing to the electric wire connection section,
wherein the seal member is a double-sided tape that has a thin base material layer having heat resistance and adhesive layers that are respectively integrally provided on front and rear surfaces of the thin base material layer.

2. The waterproof connector according to claim 1,
wherein the seal member comprises a first seal member disposed in the intermediate section and a second seal member disposed in the sheath cover section.
